(19) United States
(12) Patent Application Publication
(10) Pub. No.: US 2026/0311601 A1
(43) Pub. Date: Oct. 8, 2026

(54) System and Method for Virtual Navigation Infrastructure for Personal and Light Aerial Mobility Devices

(71) Applicant: Ori Meir Pnini, Tel Aviv (IL)

(72) Inventor: Ori Meir Pnini, Tel Aviv (IL)

(21) Appl. No.: 19/169,035

(22) Filed: Apr. 3, 2025

(51) Int. Cl. G08G 5/50; G08G 5/23; G08G 5/26; G08G 5/30

(52) U.S. Cl. CPC G08G 5/50; G08G 5/23; G08G 5/26; G08G 5/30

(57) ABSTRACT

A system and method for supporting or enabling navigation functionality in light and personal aerial mobility devices (LPAMDs). The system may include one or more components selected from: a route generation mechanism, waypoint and marker management, a communication interface with aerial devices, visual or non-visual navigation presentation modules, and autonomous or semi-autonomous flight control logic. Navigation data may be generated, coordinated, or conveyed using real-time or static inputs, in dynamic or preconfigured modes, and delivered through various perceptual outputs including visual overlays, audio, or haptic feedback. The system may be implemented in full or in part, and applies across a range of aerial mobility platforms, without requiring any fixed combination of components, configurations, or implementation methods.

### BACKGROUND OF THE INVENTION

As aerial mobility continues to evolve, new categories of lightweight and personal transportation devices have emerged, including but not limited to individual flight systems, wearable propulsion technologies, compact aerial vehicles, autonomous delivery platforms, and other configurations. These platforms, referred to herein as Light and Personal Aerial Mobility Devices (LPAMDs), may vary significantly in design, capabilities, and operating environments. Examples may include, but are not limited to, personal jetpacks, wearable propulsion systems, small aerial vehicles, delivery drones, autonomous aerial taxis, or other current or future aerial platforms.

Existing navigation solutions, primarily based on conventional GPS routing or legacy aviation systems, do not adequately serve the operational and contextual requirements of LPAMDs. Unlike traditional aircraft, LPAMDs often operate in constrained, dynamic, or low-altitude environments that require adaptable, scalable, and decentralized navigation support.

There is therefore a need for a flexible, modular system capable of supporting various forms of virtual navigation functionality, including but not limited to the management of navigation paths, airspace boundaries, and spatial markers. The system may utilize dynamic or static data, and may operate in real-time, delayed, or offline modes depending on the use case and technical implementation. This invention addresses these needs while remaining adaptable to different operational scenarios and integration architectures.

### SUMMARY OF THE INVENTION

The invention provides a system and method that may be applied to enabling structured navigation and spatial coordination for personal and light aerial mobility devices. This includes generation, coordination, or updating of virtual navigation paths, waypoints, flight corridors, or contextual airspace elements, without requiring centralized traffic management. No specific combination or behavior is required for an implementation to fall within the scope of the invention.

This invention enables a structured yet adaptable layer of navigation and aerial space organization tailored to personal and light aerial mobility, which is not addressed by existing aviation systems. The invention defines a virtual navigation infrastructure for aerial mobility, functioning as an organized but flexible spatial framework adapted for low-altitude and personal air traffic. Whether implemented through virtual path generation and presentation, perceptual guidance, autonomous coordination, or any combination thereof, the invention introduces methods and mechanisms that support navigation in environments lacking conventional airspace control—without requiring exclusive reliance on any single approach.

In contrast to traditional navigation systems designed for centralized air traffic management or pre-scheduled aviation, this invention enables flexible and context-specific virtual navigation and management designed around the operational characteristics of personal and light aerial mobility, without requiring centralized air traffic control structures. It addresses the emerging need for coordinating movement, providing intuitive navigation feedback, and maintaining spatial awareness in unregulated or semi-regulated aerial environments, without requiring dependence on centralized infrastructure or commercial control systems. The system may serve as a virtual equivalent of roadway infrastructure for aerial mobility—providing structure, separation, and orientation—without requiring direct control or management of aerial devices themselves.

This system is capable of: Supporting aerial navigation for the device—whether in fully autonomous, semi-autonomous, or manually piloted modes, with autonomous functionality being optional and not required for an implementation to fall within the scope of the invention, and Providing or delivering navigation instructions and data through visual and/or non-visual representations, which may include but are not limited to: virtual indicators, trajectory suggestions, direction cues, or contextual visual overlays adapted for personal and light aerial mobility use cases (e.g., via screen, HUD, AR), as well as audio, haptic, or other perceptual outputs. Such representations may be shown, conveyed, or made available using any technology or format suited for LPAMDs, without requiring any specific method to be present in all implementations. Any use of such representations for conveying navigational context—regardless of display form, device type, or interaction style—shall fall within the scope of the invention.

The system may operate in real-time or in preconfigured modes, depending on the implementation. The system includes logic for generating navigation paths, based on any suitable input, method, or configuration that supports aerial guidance. The specific nature, quality, or combination of data sources shall not affect inclusion within the scope of the invention. These are delivered to the device's control systems and/or to the operator or user for execution.

The invention may be applied across multiple aerial mobility configurations, such as wearable flight devices (e.g., jetpacks), vehicle-mounted systems (e.g., flying cars), autonomous taxis, delivery drones, and other aerial mobility platforms. The system is not limited to any specific configuration, platform, or mode of use. Any implementation using one or more aspects of the described functionalities may fall within the scope of the invention, regardless of the overall system composition or context. While the system is designed particularly for low-altitude operations, it remains applicable across a broader range of altitudes depending on the use case and platform capabilities.

1. A system for managing and/or presenting virtual navigation guidance for light and personal aerial mobility devices, the system comprising one or more components selected from the group consisting of: (a) a route generation engine; (b) a spatial navigation management module; (c) a device interface for communicating navigation instructions; (d) a presentation module for delivering navigation data to a user or system; (e) an autonomous flight control interface or logic; wherein implementations using any one or more of the above components or their equivalents fall within the scope of the invention, regardless of naming, arrangement, or integration with other systems.

2. The system of claim 1, wherein the aerial mobility device comprises a jetpack, wearable flight apparatus, single-occupant aerial vehicle, aerial taxi, or autonomous delivery drone, and any implementation utilizing such a device in conjunction with one or more components of the system shall fall within the scope of the invention.

3. The system of claim 1, wherein the route generation engine may utilize machine learning or any other algorithmic approach to adapt routing based on traffic, environmental, historical, or any relevant data sources, individually or in combination.

4. The system of claim 1, wherein the presentation module may comprise a head-up display (HUD), an augmented reality (AR) interface—whether implemented via headset, screen, transparent display, or any other visual output—or any mechanism capable of conveying navigation-related information through any perceptual channel, without requiring support for all such formats in any specific implementation.

5. The system of claim 1, wherein the device interface may support bi-directional, uni-directional, intermittent, or persistent communication for receiving telemetry or adjusting navigation, and any implementation that enables such data exchange shall fall within the scope of the invention.

6. The system of claim 1, wherein the route generation engine and spatial navigation management module may provide navigation paths and waypoints that are precomputed, fixed, or otherwise not updated during flight, and such static implementations remain within the scope of the invention.
